(19) United States
(12) Patent Application Publication
(10) Pub. No.: US 2015/0085090 A1
(43) Pub. Date: Mar. 26, 2015

(54) THREE-DIMENSIONAL DISPLAY DEVICE AND THREE-DIMENSIONAL DISPLAY METHOD THEREOF

(71) Applicant: Shenzhen China Star Optoelectronics Technology Co. Ltd., Shenzhen, Guangdong (CN)

(72) Inventors: Cheng-hung Chen, Shenzhen City (CN); Jiali Jiang, Shenzhen City (CN)

(73) Assignee: Shenzhen China Star Optoelectronics Technology Co. Ltd., Shenzhen, Guangdong (CN)

(21) Appl. No.: 14/233,384

(22) PCT Filed: Oct. 23, 2013
(86) PCT No.: PCT/CN2013/085775

§ 371 Date: Jan. 17, 2014

(30) Foreign Application Priority Data
Sep. 25, 2013 (CN) 2013104433089

(51) Int. Cl. H04N 13/04; H04N 13/00

(52) U.S. Cl. CPC H04N 13/045; H04N 13/0022; H04N 13/0497
USPC 348/55

(57) ABSTRACT

The present invention provides a 3D display device and 3D display method thereof. The method includes the steps of: providing a first signal to the display panel sequentially for providing left-eye image and right-eye image sequentially, and providing a second signal at the time of switching the left-eye image and the right-eye image for inserting a black image, wherein the different 3D display quality being obtained through adjusting the insertion time of the black image. The present invention can adjust the insertion time of the black image to meet demands of higher 3D display luminance or lower 3D cross-talk for various 3D display qualities to improve viewing experience.

### BACKGROUND OF THE INVENTION

1. Field of the Invention

The present invention relates to the field of displaying techniques, and in particular to a three-dimensional display device and three-dimensional display method thereof.

2. The Related Arts

The shutter glass technique of three-dimensional (3D) display device in general suffers a problem of cross-talk. To solve the problem, the known technique is to utilize a technique called black insertion, i.e., backlight unit (BLU) blinking mode, which is realized by inserting a black image at the switching of right-eye and left-eye signals. For example, at the end of the right-eye frame, a black image is inserted, followed by the scanning of the left-eye frame. However, the black insertion technique has a fixed insertion time and the duration of the black image; in other words, the 3D display luminance and the cross-talk problem are also fixed.

As the development of the display panel technology, the viewer demands versatile in display panel quality. For 3D technology, the higher luminance and the lower cross-talk in 3D mode are both important parameters to the viewers. However, the different viewers may demand different 3D display luminance and 3D cross-talk. Thus, the known black insertion technique is unable to meet the demands of the viewers.

### SUMMARY OF THE INVENTION

The technical issue to be addressed by the present invention is to provide a 3D display device and 3D display method thereof, able to adjust the insertion time of the black image to obtain different 3D display quality based on the viewing demands to improve viewing experience.

The present invention provides a 3D display method, applicable to a 3D display device, the method comprising: providing a first signal to the 3D display device sequentially for providing left-eye image and right-eye image sequentially: providing a second signal at the time of switching the left-eye image and the right-eye image for inserting a black image; wherein the period of the left-eye image and the right-eye image being t1, the second signal being provided at a time greater than 1/2t1, inserting the black image to obtain higher 3D luminance; or, the second signal being provided at a time smaller than 1/2t1 inserting the black image to obtain lower 3D cross-talk.

According to a preferred embodiment of the present invention, to obtain a higher 3D display luminance, the insertion time of the black image is postponed later.

According to a preferred embodiment of the present invention, to obtain a lower 3d cross-talk, the insertion time of the black image is advanced earlier.

The present invention provides a 3D display method, applicable to a 3D display device, the method comprising: providing a first signal to the 3D display device sequentially for providing left-eye image and right-eye image sequentially; providing a second signal at the time of switching the left-eye image and the right-eye image for inserting a black image; wherein different 3D display quality being obtained through adjusting the insertion time of the black image.

According to a preferred embodiment of the present invention, the period of the left-eye image and the right-eye image is t1, and the step of providing a second signal at the time of switching the left-eye image and the right-eye image for inserting a black image further comprises: the second signal being provided at a time greater than 1/2t1, inserting the black image to obtain higher 3D luminance.

According to a preferred embodiment of the present invention, to obtain a higher 3D display luminance, the insertion time of the black image is postponed later.

According to a preferred embodiment of the present invention, the period of the left-eye image and the right-eye image is t1, and the step of providing a second signal at the time of switching the left-eye image and the right-eye image for inserting a black image further comprises: the second signal being provided at a time smaller than 1/2t1 inserting the black image to obtain lower 3D cross-talk.

According to a preferred embodiment of the present invention, to obtain a lower 3d cross-talk, the insertion time of the black image is advanced earlier.

The present invention provides a 3D display device, which comprises: a display panel, for providing display image; a driver chip, for providing a first signal to the display panel sequentially for providing left-eye image and right-eye image sequentially, and providing a second signal at the time of switching the left-eye image and the right-eye image for inserting a black image; and a controller, for controlling the driver chip to adjust the insertion time of the black image to obtain different 3D display quality.

According to a preferred embodiment of the present invention, the period of the left-eye image and the right-eye image is t1, and the controller provides the second signal at a time greater than 1/2t1, inserting the black image to obtain higher 3D luminance.

According to a preferred embodiment of the present invention, to obtain a higher 3D display luminance, the insertion time of the black image is postponed later.

According to a preferred embodiment of the present invention, the period of the left-eye image and the right-eye image is t1, and the controller provides the second signal at a time smaller than 1/2t1, inserting the black image to obtain lower 3D cross-talk.

According to a preferred embodiment of the present invention, to obtain a lower 3d cross-talk, the insertion time of the black image is advanced earlier.

The efficacy of the present invention is that to be distinguished from the state of the art. Through providing a first signal to the display panel sequentially for providing left-eye image and right-eye image sequentially, and providing a second signal at the time of switching the left-eye image and the right-eye image for inserting a black image, wherein the different 3D display quality being obtained through adjusting the insertion time of the black image, the present invention can adjust the insertion time of the black image to meet demands of higher 3D display luminance or lower 3D cross-talk for various 3D display qualities to improve viewing experience.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a flowchart of a preferred embodiment of 3D display method according to the present invention;

FIG. 2 is a schematic view showing the waveform of the first signal and the second signal of the 3D display method according to the present invention;

FIG. 3 is a schematic view showing another waveform of the first signal and the second signal of the 3D display method according to the present invention:

FIG. 4 is a schematic view showing the structure of an embodiment of 3D display device according to the present invention;

FIG. 5 is a plot of gamma (γ) characteristic of the known liquid crystal display device;

FIG. 6 is a schematic view illustrating the structure of a preferred embodiment of liquid crystal display device according to the present invention;

FIG. 5 is a schematic view showing the structure of another embodiment of 3D display device according to the present invention;

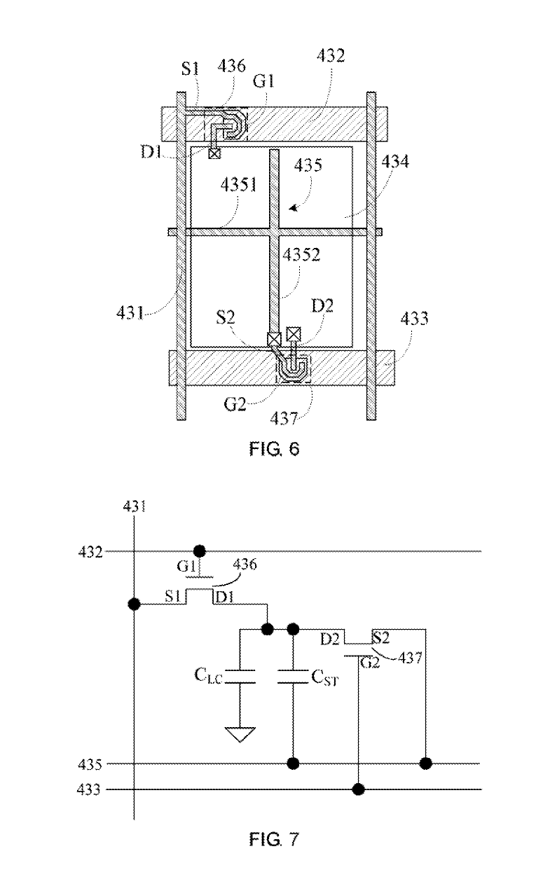

FIG. 6 is an enlarged schematic view showing the structure of pixel of FIG. 5; and

FIG. 7 is a schematic view showing the equivalent circuit of the pixel structure of FIG. 6.

### DETAILED DESCRIPTION OF THE PREFERRED EMBODIMENTS

The following refers to the drawings and embodiments for describing the present invention in details.

Referring to FIG. 1, FIG. 1 is a flowchart of a preferred embodiment of 3D display method according to the present invention. The 3D display method is applicable to a 3D display device. As shown in FIG. 1, the 3D display method of the present invention comprises the following steps:

Step S1: providing a first signal to the display panel sequentially for providing left-eye image and right-eye image sequentially.

Step S2: providing a second signal at the time of switching the left-eye image and the right-eye image for inserting a black image, wherein the different 3D display quality being obtained through adjusting the insertion time of the black image.

The 3D display method of the present invention can adjust the insertion time of the black image to meet demands of higher 3D display luminance or lower 3D cross-talk for various 3D display qualities to improve viewing experience.

The present invention further provides another embodiment of 3D display method for detailed description on the basis of the above embodiment.

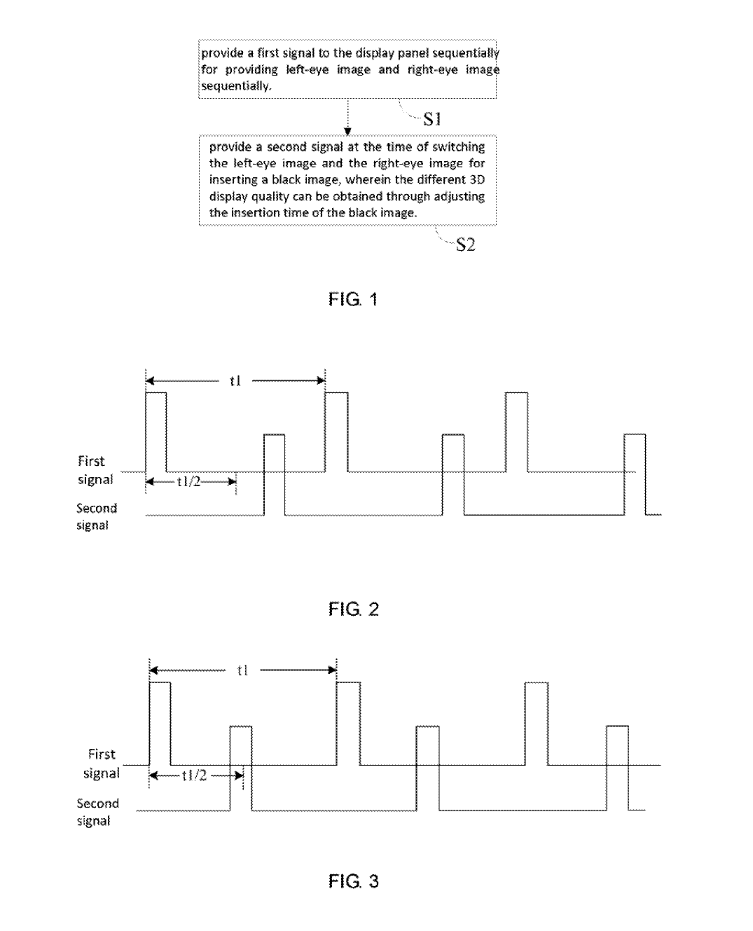

Referring to FIG. 2, FIG. 2 is a schematic view showing the waveform of the first signal and the second signal of the 3D display method according to the present invention. As shown in FIG. 2, the period of the first signal is t1. In other words, the left-eye image and the right-eye image have a period of t1. When the viewer demands higher 3D luminance, the above step S2 further comprises: providing the second signal at a time larger than 1/2t1 for inserting the black image to obtain higher 3D display luminance. In addition, the higher 3D display luminance the view demands, the later the insertion time of the black image is postponed.

When the viewer demands lower 3D cross-talk, the above step S2 further comprises: providing the second signal at a time smaller than 1/2t1 for inserting the black image to obtain lower 3D cross-talk. In addition, specifically as shown in FIG. 3, the lower 3D cross-talk the view demands, the earlier the insertion time of the black image must be advanced.

Therefore, the 3D display method of the present invention can meet demands of higher 3D display luminance or lower 3D cross-talk through postponing or advancing the insertion time of the black image to achieve various 3D display qualities to improve viewing experience.

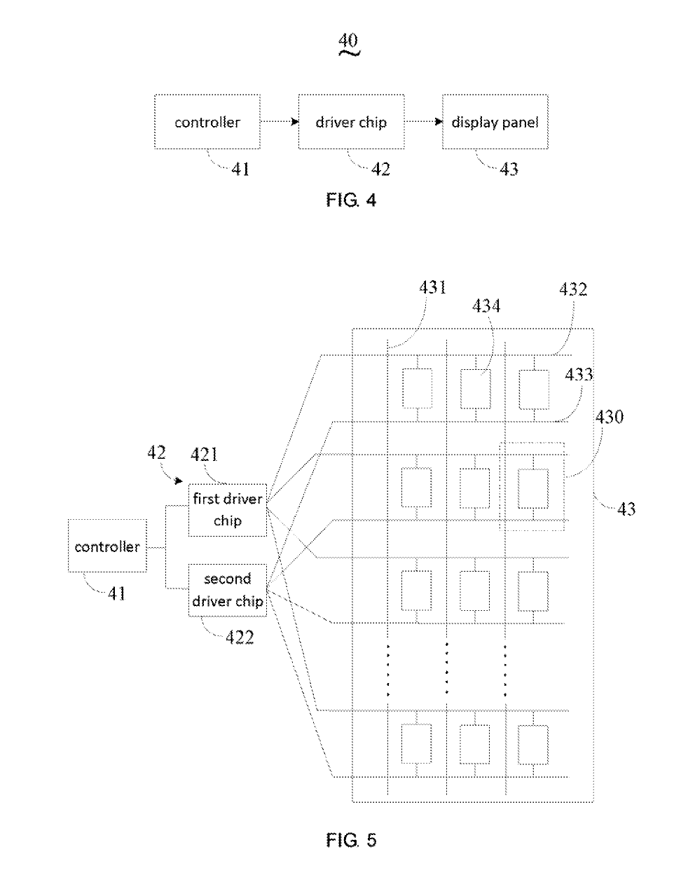

Referring to FIG. 4, FIG. 4 is a schematic view showing the structure of an embodiment of 3D display device according to the present invention. As shown in FIG. 4, the 3D display device 40 of the present invention comprises a controller 41, a driver chip 42 and a display panel 43.

In the present embodiment, the display panel 43 is for providing display image. The driver chip 42 is for providing a first signal to the display panel 43 sequentially for providing left-eye image and right-eye image sequentially, and providing a second signal at the time of switching the left-eye image and the right-eye image for inserting a black image. The controller 41 is for controlling the driver chip 42 to adjust the insertion time of the black image to obtain different 3D display quality.

Therefore, the 3D display device of the present invention can adjust the insertion time of the black image to meet demands of higher 3D display luminance or lower 3D cross-talk for various 3D display qualities to improve viewing experience.

The present invention further provides another embodiment of 3D display device for detailed description on the basis of the above embodiment. Refer to FIG. 5, FIG. 6 and FIG. 7. FIG. 5 is a schematic view showing the structure of another embodiment of 3D display device according to the present invention, FIG. 6 is an enlarged schematic view showing the structure of pixel of FIG. 5, and FIG. 7 is a schematic view showing the equivalent circuit of the pixel structure of FIG. 6. As shown in FIG. 5 and FIG. 6, the driver chip 42 comprises a first driver chip 421 and a second driver chip 422. The display panel 43 comprises a plurality of pixels 430. Each pixel 430 comprises a data line 431, a first scan line 432, intersecting perpendicularly to the data line 431, a second scan line 433, disposed in parallel with the first scan line 432, a pixel electrode 434, disposed between the first scan line 4332 and the second scan line 433, and a common electrode line 435 for providing common voltage. The pixel 430 further comprises a first switch 436, electrically connected to the first scan line 432, and a second switch 437, electrically connected to the second scan line 433.

In the present embodiment, the gate G1 of first switch 436 is electrically connected to the first scan line 432, the source S1 of the first switch 436 is electrically connected to the data line 431, and the drain D1 of the first switch 436 is electrically connected to the pixel electrode 434.

The gate G2 of second switch 437 is electrically connected to the second scan line 433, the source S2 of the second switch 437 is electrically connected to the common electrode line 435, and the drain D2 of the second switch 437 is electrically connected to the pixel electrode 434, wherein the common electrode line 435 comprises two branches 4351, 4352, disposed in a perpendicular intersection manner. The source S2 of second switch 437 is connected to the branch 4352 of the common electrode line 435.

In the present embodiment, a liquid crystal layer (not shown) is disposed above the pixel electrode 434, and the common electrode line 435 is disposed below the pixel electrode 434 Therefore, a liquid crystal capacitor (CLC) is formed between the pixel electrode 434 and the liquid crystal layer, and a storage capacitor (CST) is formed between the pixel electrode 434 and the common electrode line 435 (as shown in FIG. 7).

The following explains the operating theory of the 3D display device.

Also refer to FIG. 2 and FIG. 3. The first driver chip 421 controls the first scan line 432 to propagate the first signal to turn on the first switch 436. The data line 431 provides a pixel electrode voltage through the first switch 436 to the pixel electrode 434 so as to charge the pixel electrode 434. At the end of charging, the pixel electrode 434 is in the charged state and the second driver chip 422 controls the second scan line 433 to propagate the second signal to turn on the second switch 437. The common electrode line 435 provides a common voltage through the second switch 437 to the pixel electrode 434 to raise the voltage of the pixel electrode to the common voltage to realize the black insertion.

In the present embodiment, the controller 41 controls the first driver chip 421 ad the second driver chip 422 to output the first signal and the second signal, and further controls the second chip 422 to adjust the insertion time of the black image to obtain different 3d Display quality. Specifically, the period of the first signal is t1. When the viewer demands higher 3D luminance, the controller 41 further controls the second driver chip 422 at a time larger than 1/2t1 o provide the second signal for turning on the second switch 437. The common electrode line 435 provides a common voltage through the second switch 437 to the pixel electrode 434 to realize the black insertion to obtain higher 3D display luminance. In addition, the higher 3D display luminance the view demands, the later the insertion time of the black image is postponed.

When the viewer demands lower 3D cross-talk, the controller 41 further controls the second driver chip 422 at a time smaller than 1/2t1 to provide the second signal for turning on the second switch 437. The common electrode line 435 provides a common voltage through the second switch 437 to the pixel electrode 434 to realize the black insertion to obtain lower 3D cross-talk. In addition, the lower 3D cross-talk the view demands, the earlier the insertion time of the black image is advanced.

It should be noted that the structure of display panel 43 shown in FIGS. 5-7 is only an embodiment of the present invention. Other structures able to realize the adjustment of insertion time of the black image are also within the scope of the present invention.

Therefore, the 3D display device of the present invention can meet demands of higher 3D display luminance or lower 3D cross-talk through postponing or advancing the insertion time of the black image to achieve various 3D display qualities to improve viewing experience.

Embodiments of the present invention have been described, but not intending to impose any unduly constraint to the appended claims Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A three-dimensional (3D) display method, applicable to a 3D display device, which comprises:
providing a first signal to the 3D display device sequentially for providing left-eye image and right-eye image sequentially; and
providing a second signal at the time of switching the left-eye image and the right-eye image for inserting a black image;
wherein the period of the left-eye image and the right-eye image being t1, the second signal being provided at a time greater than 1/2t1, inserting the black image to obtain higher 3D luminance; or, the second signal being provided at a time smaller than 1/2t1, inserting the black image to obtain lower 3D cross-talk.

2. The method as claimed in claim 1, wherein to obtain a higher 3D display luminance, the insertion time of the black image is postponed later.

3. The method as claimed in claim 1, wherein to obtain a lower 3d cross-talk,
the insertion time of the black image is advanced earlier.

4. A three-dimensional (3D) display method, applicable to a 3D display device, which comprises:
providing a first signal to the 3D display device sequentially for providing left-eye image and right-eye image sequentially; and
providing a second signal at the time of switching the left-eye image and the right-eye image for inserting a black image
wherein different 3D display quality being obtained through adjusting the insertion time of the black image.

5. The method as claimed in claim 4, wherein the period of the left-eye image and the right-eye image is t1, and the step of providing a second signal at the time of switching the left-eye image and the right-eye image for inserting a black image further comprises: the second signal being provided at a time greater than 1/2 t1 inserting the black image to obtain higher 3D luminance.

6. The method as claimed in claim 5, wherein to obtain a higher 3D display luminance, the insertion time of the black image is postponed later.

7. The method as claimed in claim 4, wherein the period of the left-eye image and the right-eye image is t1, and the step of providing a second signal at the time of switching the left-eye image and the right-eye image for inserting a black image further comprises: the second signal being provided at a time smaller than 1/2 t1, inserting the black image to obtain lower 3D cross-talk.

8. The method as claimed in claim 7, wherein to obtain a lower 3d cross-talk, the insertion time of the black image is advanced earlier.

9. A three-dimensional (3D) display device, which comprises:
a display panel, for providing display image;
a driver chip, for providing a first signal to the display panel sequentially for providing left-eye image and right-eye image sequentially, and providing a second signal at the time of switching the left-eye image and the right-eye image for inserting a black image: and
a controller, for controlling the driver chip to adjust the insertion time of the black image to obtain different 3D display quality.

10. The 3D display device as claimed in claim 9, wherein the period of the left-eye image and the right-eye image is t1, and the controller provides the second signal at a time greater than 1/2 t1, inserting the black image to obtain higher 3D luminance.

11. The 3D display device as claimed in claim 10, wherein to obtain a higher 3D display luminance, the insertion time of the black image is postponed later.

12. The 3D display device as claimed in claim 9, herein the period of the left-eye image and the right-eye image is t1, and the controller provides the second signal at a time smaller than 1/2 t1, inserting the black image to obtain lower 3D cross-talk.

13. The 3D display device as claimed in claim 12, wherein to obtain a lower 3d cross-talk, the insertion time of the black image is advanced earlier.
